(19) United States
(12) Patent Application Publication
(10) Pub. No.: US 2012/0245904 A1
(43) Pub. Date: Sep. 27, 2012

(54) WAVEFORM-BASED DIGITAL GATE MODELING FOR TIMING ANALYSIS

(75) Inventors: SOROUSH ABBASPOUR, Ossining, NY (US); Peter Feldmann, New York, NY (US); Safar Hatami, Los Angeles, CA (US)

(73) Assignee: International Business Machines Corporation, Armonk, NY (US)

(21) Appl. No.: 13/071,029

(22) Filed: Mar. 24, 2011

(51) Int. Cl. G06F 17/10

(52) U.S. Cl. 703/2

(57) ABSTRACT

In one embodiment, the invention is a method and apparatus for waveform-based digital gate modeling for timing analysis. One embodiment of a method for modeling a gate of an integrated circuit chip includes building a transform matrix that indexes each input waveform/output waveform pair in a gate library to a plurality of different capacitive loads, obtaining an input waveform and a capacitive load associated with the gate, and, mapping the input waveform and the capacitive load to an output waveform for the gate, in accordance with the transform matrix.

### BACKGROUND OF THE INVENTION

The present invention relates generally to design automation, and relates more particularly to current-source model-based static timing analysis.

Static timing analysis is a key tool used for design optimization and testing of very large scale integrated (VLSI) circuit chips. Both the cost and the performance of the circuit design will be affected by static timing analysis. One particularly important factor in timing accuracy is the fidelity of gate models.

Two standard gate modeling approaches typically used throughout the circuit industry are effective current source modeling (ECSM) and composite current source (CCS) modeling. Both of these approaches contain separate models for timing, noise, and power applications. In addition, both approaches permit accurate computation of the driver output waveform and use model order reduction techniques to further propagate the waveform accurately through the interconnect network to the inputs of the following gates. However, these standard approaches also tend to lose much of the detail of this meticulously calculated waveform.

FIG. 1, for instance, illustrates an exemplary driver output waveform (Tₒᵤₜ) calculated using ECSM. In this example, the propagation delay model for the following gate is indexed accordingly only to the slew rate of the incoming waveform. Therefore, the model of the incoming signal (Tⁱⁿ) must be reduced to use only a single parameter value (i.e., slew). As illustrated, the rest of the details of the waveform shape are lost.

### SUMMARY OF THE INVENTION

In one embodiment, the invention is a method and apparatus for waveform-based digital gate modeling for timing analysis. One embodiment of a method for modeling a gate of an integrated circuit chip includes building a transform matrix that indexes each input waveform/output waveform pair in a gate library to a plurality of different capacitive loads, obtaining an input waveform and a capacitive load associated with the gate, and, mapping the input waveform and the capacitive load to an output waveform for the gate, in accordance with the transform matrix.

In another embodiment, a computer readable storage device contains an executable program for modeling a first gate of an integrated circuit chip. The program performs steps of: building a transform matrix that indexes each input waveform/output waveform pair in a gate library to a plurality of different capacitive loads, obtaining an input waveform and a capacitive load associated with the first gate, and mapping the input waveform and the capacitive load to an output waveform for the first gate, in accordance with the transform matrix.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary driver output waveform calculated using effective current source modeling;

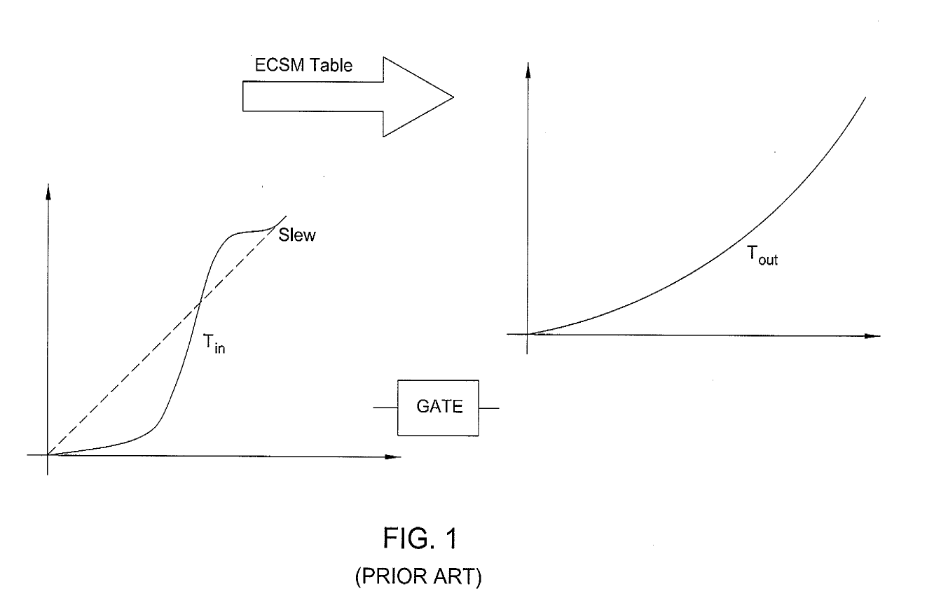

FIG. 2 is a flow diagram illustrating one embodiment of a method for mapping an input waveform at an input of a gate to an output waveform at an output of the gate, according to the present invention;

FIG. 3 illustrates an exemplary waveform-based gate modeling matrices table;

FIG. 4 illustrates an exemplary chain of gates and interconnects that must be timed;

FIG. 5 is a flow diagram illustrating one embodiment of a method for propagating a waveform through a chain of gates and interconnects, according to the present invention; and

FIG. 6 is a high-level block diagram of gate modeling method that is implemented using a general purpose computing device.

### DETAILED DESCRIPTION

In one embodiment, the present invention is a method and apparatus for waveform-based digital gate modeling for timing analysis. In particular, embodiments of the present invention directly and accurately map waveforms from the input of a gate to the output of the gate. This enables the present invention to overcome the loss of waveform accuracy at a gate input by propagating full waveforms through successive stages of logic and interconnects. In some embodiments, the waveform is represented and propagated efficiently through the logic chain using a small set of basis functions.

In particular, given an input waveform and a capacitive load, embodiments of the present invention compute the output waveform as a function of the input waveform directly from library characterization data. For arbitrary RC(L) (i.e., a synthesis of a passive resistive-capacitive (RC) network and a resistive-capacitive-inductive (RCL) network) output loads, the present invention creates waveform tables as a function of input waveforms. The waveform tables are then used in a modeling step to compute accurate delays and output waveforms.

Embodiments of the present invention are compatible with standard current source models (e.g., ECSM, CCS, and the like) and can be integrated into timing analysis tools that are based on these models with minimal loss of efficiency. Embodiments of the invention are discussed within the exemplary context of gate models based on voltage waveforms (which are typical of ECSM); however, the present invention is equally applicable to models based on current waveforms (which are typical of CCS).

Waveform based gate modeling according to one embodiment of the present invention starts with a time vector representing the monotonic time versus voltage waveform for various cells in a library. Thus, the terms “waveform” and “time vector” are used interchangeably herein. This time vector, T, is represented as:

T=[t₀,t₁, . . . ,t_{d-1}] (EQN. 1)

A corresponding voltage vector, V, is represented as:

V=[v₀,v₁, . . . ,v_{d-1}] (EQN. 2)

In the cases of EQNs. 1 and 2, tₖ, k=0, . . . , d−1 represents the time instances at which the voltage waveform crosses a threshold voltage level, vₖ (e.g., some percentage of the supply voltage Vdd).

Each time vector T can be represented as a linear combination of basis vectors Uₖ, k=0, . . . , d−1 as:

T=ΣαₖUₖ^{t} (EQN. 3)

where αₖ is the k^{th} coefficient of the time vector T, and UₖεR^{dx1} is a column vector. In one embodiment, the basis vectors, Uₖ, are obtained by performing principal component analysis (PCA) on a large set of realistic time vectors.

The average time, t_{M}, of a waveform T is the average of all of the time instances of the waveform and can be expressed mathematically as:

t_{M}=(t₀+t₁+ . . . +t_{d-1})/d (EQN. 4)

Moreover, since

$${U}_{0} = {[ \frac{1}{\sqrt{d}} , \frac{1}{\sqrt{d}} , … , \frac{1}{\sqrt{d}} ]}^{T}$$

$$and$$

$${α}_{0} = {TU}_{0} = {[ {t}_{0} , {t}_{1} , … , {t}_{d - 1} ] [ \frac{1}{\sqrt{d}} , \frac{1}{\sqrt{d}} , … , v ]}^{T} \qquad ( EQN . 5 )$$

then t_{M} can also be expressed as:

$${t}_{M} = \frac{{α}_{0}}{\sqrt{d}} \qquad ( EQN . 6 )$$

Using the above information, one can map a waveform at the input of a gate G to a corresponding output of the gate G for a capacitive load Cᵣ. One embodiment of a method for performing this mapping operation is based on a characterization step performed for each input-output pair of each cell in a gate library, with varying capacitive loads. In one embodiment, this characterization step is performed offline. The result is a transformation matrix including a plurality of coefficients of a mapping function specific to each capacitive load. The transformation matrix and the coefficients are then used to calculate the output waveform.

Embodiments of the invention consider, for the input-output pair associated with a given gate, G, the input time vector, Tᵢₙ, the output load Cᵣ, and the associated output time vector T^{out}. Tⁱⁿ and T^{out} are time vectors as given by EQN. 1. Tⁱⁿ and T^{out} can also be approximated accurately by the first q basis waveforms as:

Tⁱⁿ=ΣαₖUₖ^{T}

T^{out}=ΣβₖUₖ^{T} (EQN. 7)

where k=0, 1, . . . , q−1; and where

X=[α₀,α₁, . . . ,α_{q-1}]=Tⁱⁿ[U₀,U₁, . . . ,U_{q-1}]

Y=[β₀,β₁, . . . ,β_{q-1}]=T^{out}[U₀,U₁, . . . ,U_{q-1}] (EQN. 8)

and where U₀, U₁, . . . , U_{q-1} are the first q basis vectors. Thus, the coefficients α and β correspond to basis vectors for the input waveform and the output waveform, respectively. For instance, α₀ may represent a delay adjustment, while α₁ represents a slew adjustment, and α₂ represents a skewness adjustment.

Embodiments of the present invention map X to Y by formulas containing quadratic and square root terms of waveform coefficients, where the quadratic cross-product terms are negligible and can be ignored. EQN. 8 can thus be rewritten as:

[β₀,β₁, . . . ,β_{q-1}]=[1α₀,α₁, . . . ,α_{q-1},α₀²α₁², . . . ,α_{q-1}²,α₀^{0.5}α₁^{0.5}, . . . ,α_{q-1}^{0.5}]F (EQN. 9)

where FεR^{3q+1xq} and F is a waveform-based gate model matrix.

The principal coefficients of the output waveform can thus be calculated from the basis coefficients of the input waveform using EQN. 9.

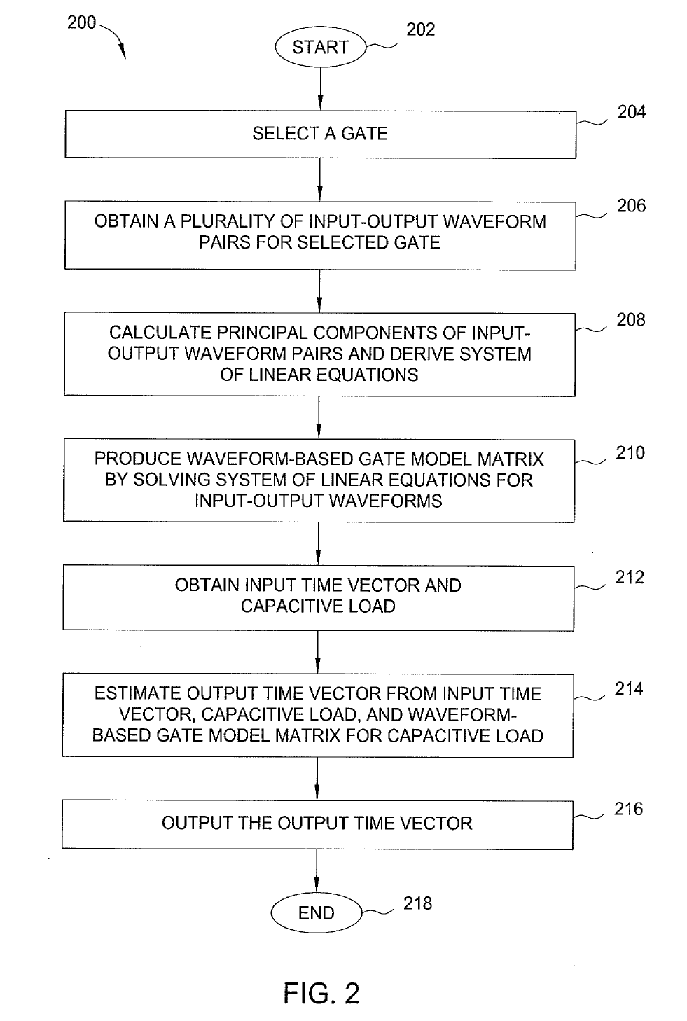

FIG. 2 is a flow diagram illustrating one embodiment of a method 200 for mapping an input waveform at an input of a gate to an output waveform at an output of the gate, according to the present invention.

The method 200 is initialized at step 202 and proceeds to step 204, where a gate, G, is selected. The gate G drives a capacitive load Cᵣ, as discussed above.

In step 206, a plurality, P, of input-output waveform pairs are obtained for the gate G. In one embodiment, the input-output waveform pairs are obtained using transient simulation program with integrated circuit emphasis (SPICE) simulation, as discussed in greater detail below.

In step 208, the principal coefficients of the P input-output waveform pairs are calculated. In one embodiment, the principal components are calculated in accordance with EQN. 8. This allows the derivation of the coefficients of a system of linear equations as follows:

[1α₀α₁, . . . ,α_{q-1},α₀²α₁², . . . ,α_{q-1}²,α₀^{0.5}α₁^{0.5}, . . . ,α_{q-1}²]ⁱ

and

└\tilde{β}₀ⁱ\tilde{β}₁ⁱ, . . . ,\tilde{β}_{q-1}ⁱ┘

as discussed with respect to EQN. 9. The index i refers to the i^{th} pair of input-output waveforms for i=1, 2, . . . , P. The terms \tilde{β}ₖⁱ are the exact values of βₖ for k=0, 1, . . . q−1. The terms \tilde{β}ₖⁱ are calculated from the principal coefficients of the i^{th} pair of input-output waveforms. Due to a modeling approximation, the βₖ values produced by EQN. 9 are not the exact \tilde{β}ₖⁱ values produced by simulation (e.g., SPICE simulation).

In step 210, the waveform-based gate model matrix, F, is produced. In one embodiment, the waveform-based gate model matrix F is produced by solving (e.g., in the least squares sense) the following over-determined system of linear equations for the P pairs of input-output waveforms:

[\tilde{β}₀ⁱ\tilde{β}₁ⁱ, . . . , \tilde{β}_{q-1}ⁱ]=[1α₀,α₁, . . . ,α_{q-1},α₀²,α₁², . . . ,α_{q-1}²,α₀^{0.5},α₁^{0.5}, . . . ,α_{q-1}^{0.5}]ⁱF (EQN. 11)

where the waveform-based gate model matrix F is a (3q+1) by q matrix. Hence, the number of elements in the transform matrix is 3q²+q.

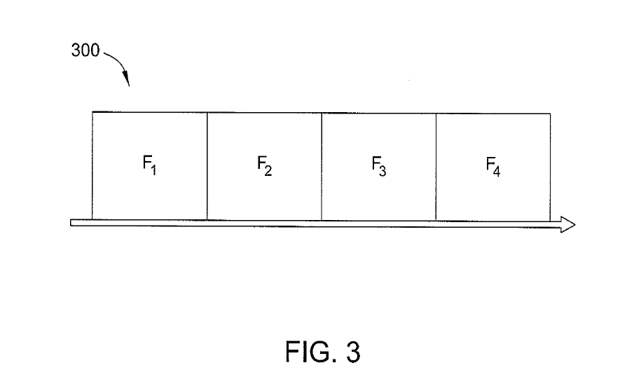

FIG. 3, for example, illustrates an exemplary waveform-based gate modeling matrices table 300. Specifically, the table 300 (also represented as Ψ) illustrates the modeling matrices for four different capacitive loads Cᵣ. Each element of the table 300 is shown as follows:

Fᵣ=Ψ(Cᵣ) (EQN. 12)

where r is the index of the capacitive load Cᵣ in the table Ψ.

Step 210 is performed once for each input-output waveform pair in the library. In one embodiment, step 210 is an offline process. Steps 204-210 result in each input-output waveform pair being characterized. The remaining steps of the method 200 then generate an output time vector T^{out} for an arbitrary input time vector Tⁱⁿ and arbitrary capacitive load Cᵣ.

In step 212, the input time vector Tⁱⁿ and the capacitive load Cᵣ are obtained. The output time vector T^{out} is then estimated in step 214 from the input time vector Tⁱⁿ, and the capacitive load Cᵣ, and the corresponding waveform-based gate model matrix Fᵣ as follows:

[α₀α₁, . . . ,α_{q-1}]=Tⁱⁿ[U₀U₁, . . . ,U_{q-1}] (EQN. 13)

[β₀β₁, . . . ,β_{q-1}]=[1α₀,α₁, . . . ,α_{q-1},α₀²,α₁², . . . ,α_{q-1}²,α₀^{0.5},α₁^{0.5}, . . . ,α_{q-1}^{0.5}]F

T^{out}=[β₀,β₁, . . . ,β_{q-1}][U₀U₁, . . . ,U_{q-1}]^{T}

As discussed above, the waveform-based gate model matrices F are calculated for each capacitive load Cᵣ via the characterization steps 204-210. The output time vector T^{out} is then output in step 216, and the method 200 terminates in step 218.

Once the output waveform T^{out} has been estimated, it can be propagated through arbitrarily loaded gates so that during timing analysis, a chain of gates and interconnects can be timed with maximum accuracy. In one embodiment, propagation of the output waveform T^{out} estimated using the method 200 is performed using a standard modeling technique such as ECSM or CCS.

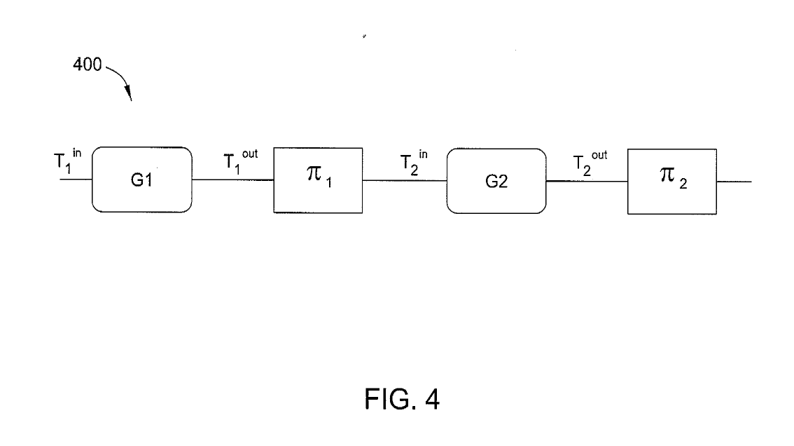

FIG. 4, for instance, illustrates an exemplary chain 400 of gates and interconnects that must be timed. Specifically, static timing analysis needs to propagate the waveform T₁ⁱⁿ through the chain 400.

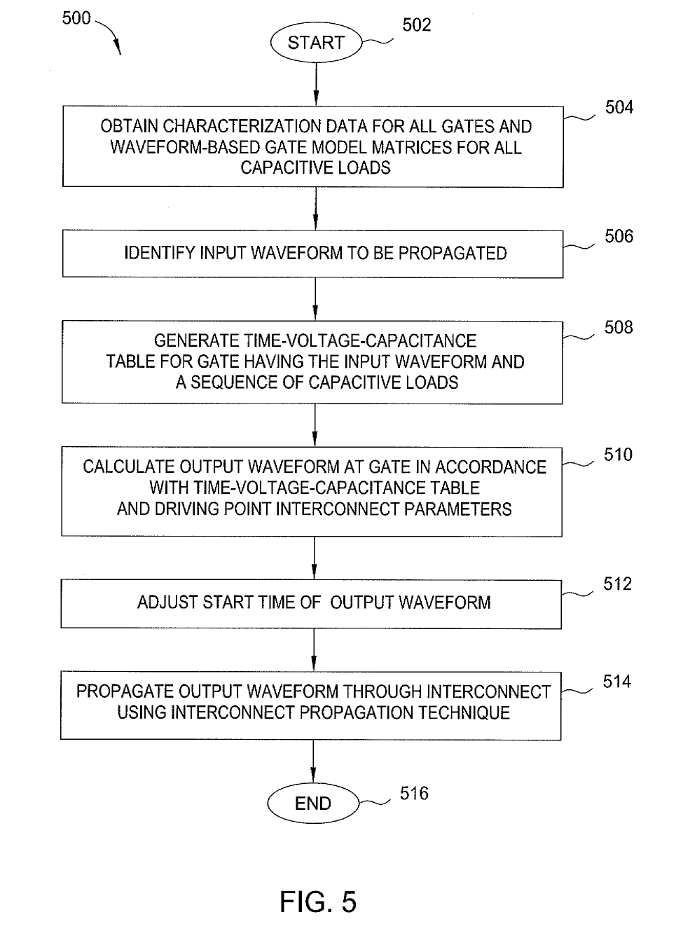

FIG. 5 is a flow diagram illustrating one embodiment of a method 500 for propagating a waveform through a chain of gates and interconnects, according to the present invention. Specifically, the method 500 implements the waveform-based gate modeling technique illustrated in FIG. 2 with ECSM; however, the waveform-based gate modeling technique of FIG. 2 could also be implemented in conjunction with other modeling techniques such as CCS. For ease of explanation, reference is made within the discussion of the method 500 to various elements of the chain 400 illustrated in FIG. 4. However, the method 500 may be applied to any chain of gates and interconnects.

The method 500 is initialized in step 502 and proceeds to step 504, where the characterization data for all gates G in the chain and the waveform-based gate model matrices F for all capacitive loads Cᵣ are obtained. This step assumes that all of the gates G have already been characterized and that the waveform-based gate model matrices F are stored in the library.

In step 506, an input waveform Tᵢⁱⁿ (i.e., the input waveform to the gate Gᵢ) to be propagated is identified. The input waveform Tᵢⁱⁿ drives an arbitrary RC(L) load.

In step 508, using F matrices (given by Ψ in EQN. 12), the two-dimensional Time-Voltage-Capacitance table, Γ=f_{Γ}(V, C), is generated for the gate Gᵢ with the input waveform Tᵢⁱⁿ and a sequence of discrete capacitive loads Cₖ. This produces the rows of the table, Γₖ=f_{Γ}(V, Cₖ). In fact, Γₖ is the output waveform of Gᵢ associated with the input waveform Tᵢⁱⁿ and the capacitive load Cₖ. In accordance with the method 200, the table Γ is generated dynamically during timing analysis to reflect the exact shape of the input.

In step 510, the output waveform \hat{T}ᵢ^{out} at the output driving point of the gate Gᵢ is calculated, in accordance with the Time-Voltage-Capacitance table Γ=f_{Γ}(V, C) and the driving point interconnect parameters (e.g., poles and residues). In one embodiment, this calculation is performed using ECSM. ECSM, will only compute the shape of the output waveform, but will not provide an absolute start time of the waveform (delay). Therefore, in step 510, the output waveform \hat{T}ᵢ^{out} is started at the origin time point (i.e., tome zero). The output waveform \hat{T}ᵢ^{out} does not have an absolute time reference.

ECSM will, however, produce a byproduct that is useful in the delay calculation (waveform start/reference time), namely, the vector of dynamic capacitances:

Cd=[Cd₀,Cd₁, . . . ,Cd_{d-1}] (EQN. 14)

In EQN. 14, Cdₖ refers to the dynamic capacitance of the driving point between voltage levels vₖ₋₁, vₖ.

In step 512, the starting point of the output waveform Tᵢ^{out} is calculated in accordance with the vector of dynamic capacitance Cd. This adjusts the start time of the output waveform Tᵢ^{out}. In particular, the voltage level, V_{M}, corresponding to the average time t_{M} of the output waveform \hat{T}ᵢ^{out} is first calculated (t_{M} in this case is the zeroeth coefficient divided by \sqrt{d} as given in EQN. 6). Next, using the vector of dynamic capacitance Cd, the vector v given by EQN. 2, and some interpolation, the dynamic capacitance Cd(v_{M}) corresponding to the voltage level v_{M} is calculated. The Time-Voltage-Capacitance table Γ=f_{Γ}(V, C) generated for the input waveform Tᵢⁱⁿ is next used to obtain the vector Tₓ that includes the first time instances of all time vectors, Γₖ's, included in the Time-Voltage-Capacitance table Γ. Using interpolation, the vector Tₓ, and the vector C, the first time instance t₀ⁱ corresponding to the capacitance Cd(v_{M}) can be calculated. Finally, the time instance t₀ⁱ is used as the reference time for the output waveform Tᵢ^{out} as given by:

Tᵢ^{out}=\hat{T}ᵢ^{out}+t₀ⁱ (EQN. 15)

In step 514, the output waveform is propagated through the interconnect using an interconnect propagation technique. For example, the MAISE interconnect simulation engine is one technique that may be used for waveform propagation in accordance with step 514. The method 500 then terminates in step 516.

As discussed above, a portion of the method 200 is characterizing input-output waveform pairs. In particular, a set of input waveforms is created, where the set spans the space of all possible monotonic waveforms that can occur in a design (in order to assure that the waveform-based gate modeling technique captures the behavior of the gate for any input waveform). In one embodiment, the set of input waveforms is created in accordance with one of two approaches: (1) a physical approach; and (2) a synthetic approach.

In the physical approach, a driver circuit is used to feed the gate with waveforms of different shapes. The driver circuit can be tuned with different variables to create various input waveforms. In particular, the values for certain capacitances and resistances in the driver circuit can be varied to change the shapes of the waveforms.

The synthetic approach mathematically creates the input waveforms by changing the PCA coefficients of the PCA basis of a set of waveforms. The generated waveforms are physical, real, and possible to generate in a circuit. This approach seeks to span all of the waveforms that are required to capture the important attributes of the gates.

As also discussed above, the basis of a set of waveforms may be obtained through PCA. In one embodiment, the PCA coefficients are obtained through two major steps: (1) a pre-processing step; and (2) a basis extraction and coefficient calculation step.

The pre-processing step starts with a matrix S_{nxd} of time vectors representing the monotonic time versus voltage waveforms, where n is the number of waveforms in S and d is the number of time instances for each waveform. The voltages are assumed to be normalized to the 0-1V interval, and the thresholds are expressed as percentages. Affine transform (shift and scale), averaging, and weighting operations are then applied to the matrix S.

The basis extraction and coefficient calculation step involves using PCA to compute a new basis for representing a waveform as:

S_{nxd}=LΣU^{T}=[αᵢₖ]U^{T} (EQN. 16)

where Σ is a diagonal matrix of singular values in decreasing order, and the columns of U represent orthogonal bases of waveforms (each column Uₖ of U is a principal component). Each time vector S can be written as a linear combination of principal components as given by EQN. 3.

By setting the “small” singular values to zero, a low rank approximation of the original matrix is obtained. This low rank representation is in terms of a subset of basis vectors that is optimal in the sense of minimizing the “average” error.

Embodiments of the invention may be extended to multi-stage gate modeling. In this case, a combined model of a multi-stage gate may be obtained from the detailed model of each stage/gate/interconnect. All gates are then modeled using a single gate.

Embodiments of the invention may also be extended to multi-transition gate modeling. In this case, a gate with multiple inputs/transitions is modeled by capturing the elative relations among the basis components of the input waveforms and transforming the output. This stands in contrast to the method 200 discussed above, which assumes one input for each gate.

Embodiments of the invention may also be extended to gate modeling to statistical timing analysis. In this case, the waveform-based gate modeling techniques discussed above are used to model gates for different process-voltage-temperature operating conditions and to propagate variational waveforms.

Embodiments of the invention may also be extended to enhance component-based noise analysis. In this case, the principal components of noisy waveforms are captured using additional coefficients. The gates are then modeled for the principal components of any arbitrary noisy waveform.

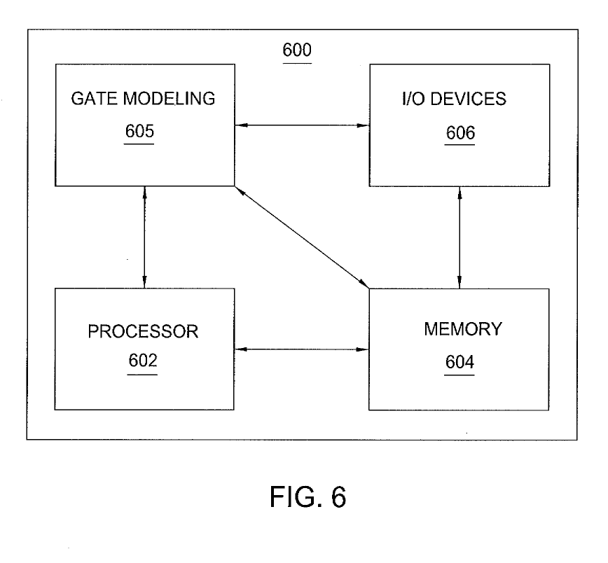

FIG. 6 is a high-level block diagram of gate modeling method that is implemented using a general purpose computing device 600. In one embodiment, a general purpose computing device 600 comprises a processor 602, a memory 604, a gate modeling module 605 and various input/output (I/O) devices 606 such as a display, a keyboard, a mouse, a stylus, a wireless network access card, and the like. In one embodiment, at least one I/O device is a storage device (e.g., a disk drive, an optical disk drive, a floppy disk drive, a path selection tool, and/or a test pattern generation tool). It should be understood that the gate modeling module 605 can be implemented as a physical device or subsystem that is coupled to a processor through a communication channel.

Alternatively, the gate modeling module 605 can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the gate modeling module 605 for performing waveform-based digital gate modeling for timing analysis, as described herein with reference to the preceding Figures, can be stored on a computer readable storage device (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A method for modeling a first gate of an integrated circuit chip, the method comprising:
building a transform matrix that indexes each input waveform/output waveform pair in a gate library to a plurality of different capacitive loads;
obtaining an input waveform and a capacitive load associated with the first gate; and
mapping the input waveform and the capacitive load to an output waveform for the first gate, in accordance with the transform matrix,
wherein at least one of: the building, the obtaining, or the mapping is performed by a processor.

2. The method of claim 1, wherein the building is performed offline.

3. The method of claim 1, wherein the building comprises:
calculating a set of principal components for the each input waveform/output waveform pair;
deriving from the set of principal components a system of linear equations; and
solving the system of linear equations.

4. The method of claim 1, further comprising:
propagating the output waveform through at least a second gate in the integrated circuit chip.

5. The method of claim 4, wherein the propagating is performed during timing analysis of the integrated circuit chip.

6. The method of claim 4, wherein the propagating comprises:
computing an initial estimate of the output waveform, in accordance with the transform matrix and a set of interconnect parameters for an output driving point of the first gate;
starting the initial estimate of the output waveform at an origin time point; and
propagating the initial estimate of the output waveform through an interconnect connecting the first gate and the second gate, in accordance with an interconnect propagation technique.

7. The method of claim 6, wherein the computing is performed using effective current source modeling.

8. The method of claim 6, wherein the computing is performed using composite current source modeling.

9. The method of claim 6, wherein the computing produces as a byproduct a vector of dynamic capacitance for the output driving point of the first gate.

10. The method of claim 9, wherein a starting time point for the output waveform is calculated in accordance with the vector of dynamic capacitance.

11. The method of claim 6, wherein the propagating the initial estimate of the output waveform is performed using a MAISE interconnect simulation engine.

12. The method of claim 1, wherein each input waveform in each input waveform/output waveform pair is created using a driver circuit that is fed with a plurality of waveforms of different shapes.

13. The method of claim 12, wherein a value for at least one capacitance or at least one resistance in the driver circuit is tunable.

14. The method of claim 1, wherein each input waveform in each input waveform/output waveform pair is created by changing a principal component analysis coefficient of a principal component analysis basis for a set of waveforms contains the each input waveform.

15. A computer readable storage device containing an executable program for modeling a first gate of an integrated circuit chip, where the program performs steps of:
building a transform matrix that indexes each input waveform/output waveform pair in a gate library to a plurality of different capacitive loads;
obtaining an input waveform and a capacitive load associated with the first gate; and
mapping the input waveform and the capacitive load to an output waveform for the first gate, in accordance with the transform matrix.

16. The computer readable storage device of claim 15, wherein the building comprises:
calculating a set of principal components for the each input waveform/output waveform pair;
deriving from the set of principal components a system of linear equations; and
solving the system of linear equations.

17. The computer readable storage device of claim 15, further comprising:
propagating the output waveform through at least a second gate in the integrated circuit chip.

18. The computer readable storage device of claim 17, wherein the propagating is performed during timing analysis of the integrated circuit chip.

19. The computer readable storage device of claim 17, wherein the propagating comprises:
computing an initial estimate of the output waveform, in accordance with the transform matrix and a set of interconnect parameters for an output driving point of the first gate;
starting the initial estimate of the output waveform at an origin time point; and
propagating the initial estimate of the output waveform through an interconnect connecting the first gate and the second gate, in accordance with an interconnect propagation technique.

20. Apparatus for modeling a first gate of an integrated circuit chip, the apparatus comprising:
means for building a transform matrix that indexes each input waveform/output waveform pair in a gate library to a plurality of different capacitive loads;
means for obtaining an input waveform and a capacitive load associated with the first gate; and
means for mapping the input waveform and the capacitive load to an output waveform for the first gate, in accordance with the transform matrix.
